(19) United States
(12) Patent Application Publication
(10) Pub. No.: US 2025/0233556 A1
(43) Pub. Date: Jul. 17, 2025

(54) BASEPLATES FOR PHOTOVOLTAIC MODULES

(71) Applicant: GAF Energy LLC, Parsippany, NJ (US)

(72) Inventors: Richard Perkins, San Jose, CA (US); Brian West, San Francisco, CA (US); Gary Rossi, San Francisco, CA (US)

(21) Appl. No.: 19/016,769

(22) Filed: Jan. 10, 2025

Related U.S. Application Data
(60) Provisional application No. 63/620,272, filed on Jan. 12, 2024.

(51) Int. Cl. H02S 40/34; H02S 20/23

(52) U.S. Cl. CPC H02S 40/34; H02S 20/23

(57) ABSTRACT

A system, including at least one photovoltaic module installed on a roof deck, where the at least one photovoltaic module is a first photovoltaic module, where each photovoltaic module includes: a first end and a second end opposite the first end, a baseplate located at the first end, a first support located on the baseplate, an electrical component located on the baseplate, a first electrical wire in electrical connection with the electrical component of the first photovoltaic module; and a first electrical connector in electrical connection with the first electrical wire, where the first electrical connector is located on the first support of the first photovoltaic module so that the first electrical connector is out of contact with the baseplate of the first photovoltaic module.

### CROSS-REFERENCE TO RELATED APPLICATION

This application is a Section 111(a) application relating to and claiming the benefit of commonly owned, co-pending U.S. Provisional Patent Application Ser. No. 63/620,272, filed Jan. 12, 2024, entitled “ROOFING SYSTEM INCLUDING PHOTOVOLTAIC MODULES,” the contents of which is incorporated herein by reference in its entirety.

### FIELD

The present invention is directed to a roofing system, and, more specifically, to a roofing system including photovoltaic modules installed on a roof deck.

### BACKGROUND

A known roofing system includes photovoltaic modules installed on a roof deck. The photovoltaic modules include solar cells that produce electricity from sunlight. Wires electrically connect the photovoltaic modules to one another.

### SUMMARY

The Claims, rather than the Summary, define covered embodiments of the present invention. The Summary is a high-level overview of various aspects of the invention, and introduces concepts that are further described in the Detailed Description below. The Summary is not intended to identify key or essential features of the claimed subject matter, and also is not intended to be used in isolation to determine the scope of the claimed subject matter. Instead, the claimed subject matter should be understood by reference to appropriate portions of the Specification and drawings, as well as to each claim.

In some embodiments, the present invention provides a roofing system, comprising: a roof deck; at least one photovoltaic module installed on the roof deck, wherein the at least one photovoltaic module comprises a first photovoltaic module, wherein each photovoltaic module includes: a first end and a second end opposite the first end, a baseplate located at the first end, a first support located on the baseplate, an electrical component located on the baseplate, a first electrical wire in electrical connection with the electrical component of the first photovoltaic module; and a first electrical connector in electrical connection with the first electrical wire, wherein the first electrical connector is located on the first support of the first photovoltaic module so that the first electrical connector is out of contact with the baseplate of the first photovoltaic module.

In some embodiments, the first support comprises a polymer.

In some embodiments, the first support comprises a composite material.

In some embodiments, the first support comprises silicone.

In some embodiments, the first support comprises at least one of poly (p-phenylene ether) (PPE), or polystyrene (PS).

In some embodiments, the first support comprises a material with a thermal conductivity of 0.02 W/m-K to 0.2 W/m-K.

In some embodiments, the first support comprises a material with a thermal conductivity of 0.1 W/m-K to 0.2 W/m-K.

In some embodiments, the first support comprises a material with a thermal conductivity of 0.02 W/m-K to 0.05 W/m-K.

In some embodiments, the first support comprises a material with a thermal conductivity of less than 0.3 W/m-K.

In some embodiments, the first support comprises a same material as the baseplate.

In some embodiments, the first support comprises a different material than the baseplate.

In some embodiments, the first electrical connector separated from the baseplate of the first photovoltaic module by a gap, wherein the gap is 1 mm to 5 mm.

In some embodiments, the gap is 3 mm.

In some embodiments, the first support comprises a first protrusion and a second protrusion spaced apart from the first protrusion.

In some embodiments, a distance between the first protrusion and the second protrusion is 50 mm to 80 mm.

In some embodiments, the distance is 70 mm.

In some embodiments, the roofing system further comprises: a return wire, and a return wire connector in electrical connection with the return wire, and wherein each of the photovoltaic modules further comprises: a second support located on the baseplate, wherein the return wire connector is located on the second support of the first photovoltaic module so that the return wire connector is out of contact with the baseplate of the first photovoltaic module.

In some embodiments, the at least one photovoltaic module comprises a second photovoltaic module installed on the roof deck, wherein the second photovoltaic module at least partially overlaps the first photovoltaic module.

In some embodiments, the present invention provides a roofing system, comprising: a roof deck; at least one photovoltaic module installed on the roof deck, wherein the at least one photovoltaic module comprises a first photovoltaic module, wherein each photovoltaic module includes: a first end and a second end opposite the first end, a baseplate located at the first end, a first support located on the baseplate, an electrical component located on the baseplate, a first electrical wire in electrical connection with the electrical component of the first photovoltaic module; and a first electrical connector in electrical connection with the first electrical wire, wherein the first support of the first photovoltaic module supports the first electrical wire so that the first electrical connector is out of contact with the baseplate of the first photovoltaic module.

### BRIEF DESCRIPTION OF THE FIGURES

This section refers to the drawings that form a part of this disclosure, and which illustrate some of the embodiments of structure, materials, and/or methods of the present invention described herein.

FIG. 1 is a top schematic view of a roofing system including a roof deck, a first photovoltaic module with a baseplate and a first support, and a second photovoltaic module partially overlapping the first photovoltaic module, according to some embodiments of the invention.

FIG. 2 is a top schematic detail view of the first photovoltaic module and the second photovoltaic module of FIG. 1, according to some embodiments of the invention.

FIG. 3 is an isometric schematic view of the baseplate and the first support of the first photovoltaic module of FIGS. 1 and 2, according to some embodiments of the invention.

FIG. 4 is an isometric schematic view of the baseplate and the first support of the first photovoltaic module of FIGS. 1-3, with certain components removed, according to some embodiments of the invention.

FIG. 5 is a side, cross-sectional view of some embodiments of a photovoltaic module.

### DETAILED DESCRIPTION

In addition to the benefits and improvements that the Specification discloses, other objects and advantages that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure are intended to be illustrative, and not restrictive.

As used herein, a “steep slope” roof or roof deck is a roof or roof deck having a pitch of Y/X, where Y and X are in a ratio of 4:12 to 20:12, where Y corresponds to the “rise” of the roof or roof deck, and where X corresponds to the “run” of the roof or roof deck.

As used herein, a “sloped” roof or roof deck includes a roof or roof deck with a pitch that is less than that of a steep slope roof or roof deck, but which is not a flat roof or roof deck.

In some embodiments, the present invention provides a roofing system with one or more photovoltaic modules, and/or one or more additional roofing materials, such as but not limited to one or more non-photovoltaic modules, installed on a roof deck. In some embodiments, the roof deck is a sloped roof deck. In some embodiments, the roof deck is a steep slope roof deck. In some embodiments, the roofing system includes an underlayment between the photovoltaic module and the roof deck. In some embodiments, the roofing system omits the underlayment. In some embodiments, the roofing system includes more than one photovoltaic module. In some embodiments, the roofing system includes other components in addition and/or in place of the photovoltaic modules and/or the non-photovoltaic modules.

In some embodiments, one or more of the photovoltaic modules includes a structure, composition, component, and/or function similar to those of one or more embodiments of the photovoltaic modules and shingles disclosed, shown, and/or described in any or all of: U.S. application Ser. No. 17/831,307, filed Jun. 2, 2022, titled “Roofing Module System,” and published under U.S. Patent Application Publication No. 2022-0393637 on Dec. 8, 2022; U.S. application Ser. No. 18/169,718, filed Feb. 15, 2023, titled “Roofing Module System,” and published under U.S. Patent Application Publication No. 2023-0203815 on Jun. 29, 2023; PCT International Patent Publication No. WO 2022/051593, Application No. PCT/US2021/049017, published Mar. 10, 2022, titled “Building Integrated Photovoltaic System,” owned by GAF Energy LLC; and/or U.S. Pat. No. 11,251,744 to Bunea et al., issued Feb. 15, 2022, titled “Photovoltaic Shingles and Methods of Installing Same”; and the disclosures of each of which are incorporated by reference herein in their entireties, with certain different and/or additional features as described herein.

In some embodiments, the roofing material is a non-photovoltaic module. In some embodiments, the non-photovoltaic module is a roofing shingle. In some embodiments, the non-photovoltaic module is a cuttable roofing module. In some embodiments, the non-photovoltaic module includes a structure, composition, component, and/or function similar to those of one or more embodiments of a non-photovoltaic module and/or another roofing material disclosed, shown, and/or described in either or both of U.S. application Ser. No. 17/831,307, filed Jun. 2, 2022, titled “Roofing Module System,” and published under U.S. Patent Application Publication No. 2022-0393637 on Dec. 8, 2022; and/or U.S. application Ser. No. 18/169,718, filed Feb. 15, 2023, titled “Roofing Module System,” and published under U.S. Patent Application Publication No. 2023-0203815 on Jun. 29, 2023; and/or U.S. application Ser. No. 18/352,894, filed Jul. 14, 2023, titled “Solar Roofing System with Fiber Composite Roofing Shingles,” and the disclosures of each of which are incorporated by reference herein in their entireties, with certain different and/or additional features as described herein.

In some embodiments, the present invention provides a first support that supports a component in electrical connection with a photovoltaic module. In some embodiments, the first support is on the photovoltaic module. In some embodiments, the first support supports at least one electrical wire. In some embodiments, the first support supports at least one electrical connector. In some embodiments, the first support supports at least one electrical connector and at least one electrical wire. In some embodiments, the first support supports at least two electrical wires. In some embodiments, the first support supports at least two electrical connectors. In some embodiments, the first support supports two electrical connectors and two electrical wires.

In some embodiments, the photovoltaic module includes a first end and a second end opposite the first end. In some embodiments, the photovoltaic module includes a baseplate. In some embodiments, the baseplate is located at the first end of the photovoltaic module. In some embodiments, the baseplate is located at the second end of the photovoltaic module. In some embodiments, the first support is located on the baseplate.

In some embodiments, the photovoltaic module includes at least one electrical component. In some embodiments, the electrical component is located on the baseplate. In some embodiments, the electrical component is a power optimizer. In some embodiments, the electrical component is a junction box. In some embodiments, the electrical component is a rapid shutdown device.

In some embodiments, the first support is located on the electrical component. In some embodiments, the first support is located on the junction box. In some embodiments, the first support is located on the power optimizer. In some embodiments, the first support is located on the rapid shutdown device.

In some embodiments, a first electrical wire is in electrical connection with the electrical component. In some embodiments, a first electrical connector is in electrical connection with the first electrical wire. In some embodiments, a second electrical wire is in electrical connection with the electrical component. In some embodiments, a second electrical connector is in electrical connection with the second electrical wire.

In some embodiments, the first electrical connector is located on the first support so that the first electrical connector and/or the first electrical wire is out of contact with the baseplate of the first photovoltaic module. In some embodiments, the first support supports the first electrical wire so that the first electrical connector and/or the first electrical wire is out of contact with the baseplate. In some embodiments, the first support supports both the first electrical connector and the first electrical wire.

In some embodiments, the first support comprises a polymer. In some embodiments, the first support comprises a composite material. In some embodiments, the first support comprises silicone. In some embodiments, the first support comprises at least one of poly (p-phenylene ether) (PPE), or polystyrene (PS). In some embodiments, the first support comprises combinations of two or more of the foregoing materials. In some embodiments, the first support comprises another material.

In some embodiments, the first support comprises a material with a thermal conductivity of 0.02 W/m-K to 0.4 W/m-K. In some embodiments, the thermal conductivity is 0.03 W/m-K to 0.4 W/m-K. In some embodiments, the thermal conductivity is 0.04 W/m-K to 0.4 W/m-K. In some embodiments, the thermal conductivity is 0.05 W/m-K to 0.4 W/m-K. In some embodiments, the thermal conductivity is 0.1 W/m-K to 0.4 W/m-K. In some embodiments, the thermal conductivity is 0.2 W/m-K to 0.4 W/m-K. In some embodiments, the thermal conductivity is 0.3 W/m-K to 0.4 W/m-K.

In some embodiments, the thermal conductivity is 0.02 W/m-K to 0.3 W/m-K. In some embodiments, the thermal conductivity is 0.03 W/m-K to 0.3 W/m-K. In some embodiments, the thermal conductivity is 0.04 W/m-K to 0.3 W/m-K. In some embodiments, the thermal conductivity is 0.05 W/m-K to 0.3 W/m-K. In some embodiments, the thermal conductivity is 0.1 W/m-K to 0.3 W/m-K. In some embodiments, the thermal conductivity is 0.2 W/m-K to 0.3 W/m-K.

In some embodiments, the thermal conductivity is 0.02 W/m-K to 0.2 W/m-K. In some embodiments, the thermal conductivity is 0.03 W/m-K to 0.2 W/m-K. In some embodiments, the thermal conductivity is 0.04 W/m-K to 0.2 W/m-K. In some embodiments, the thermal conductivity is 0.05 W/m-K to 0.2 W/m-K. In some embodiments, the thermal conductivity is 0.1 W/m-K to 0.2 W/m-K.

In some embodiments, the thermal conductivity is 0.02 W/m-K to 0.1 W/m-K. In some embodiments, the thermal conductivity is 0.03 W/m-K to 0.1 W/m-K. In some embodiments, the thermal conductivity is 0.04 W/m-K to 0.1 W/m-K. In some embodiments, the thermal conductivity is 0.05 W/m-K to 0.1 W/m-K.

In some embodiments, the thermal conductivity is 0.02 W/m-K to 0.05 W/m-K. In some embodiments, the thermal conductivity is 0.03 W/m-K to 0.05 W/m-K. In some embodiments, the thermal conductivity is 0.04 W/m-K to 0.05 W/m-K.

In some embodiments, the thermal conductivity is 0.02 W/m-K to 0.04 W/m-K. In some embodiments, the thermal conductivity is 0.03 W/m-K to 0.04 W/m-K. In some embodiments, the thermal conductivity is 0.02 W/m-K to 0.03 W/m-K. In some embodiments, the thermal conductivity is less than 0.3 W/m-K.

In some embodiments, the first support comprises the same material as the baseplate. In some embodiments, the first support comprises a different material as the baseplate.

In some embodiments, the first support is connected to the baseplate. In some embodiments, the first support is adhered the baseplate. In some embodiments, the first support is adhered to the baseplate by an adhesive. In some embodiments, the first support is welded to the baseplate. In some embodiments, the first support is ultrasonically welded to the baseplate. In some embodiments, the first support is laminated to the baseplate. In some embodiments, the first support is formed with the baseplate. In some embodiments, the first support is injection molded with the baseplate. In some embodiments, the first support is co-molded with the baseplate. In some embodiments, the first support is insert molded with the baseplate. In some embodiments, the first support is not attached to the baseplate.

In some embodiments, the first support supports either or both of the first electrical connector and/or the first electrical wire, such that the first electrical connector and/or the first electrical wire is separated from the baseplate of the first photovoltaic module by a gap. In some embodiments, either or both of the first electrical connector and/or the first electrical wire are out of contact with (e.g., do not contact) the baseplate. In some embodiments, the gap is measured between a top surface of the baseplate and a surface of either the electrical wire and/or the electrical connector closest to the top surface of the baseplate.

In some embodiments, the gap is 1 mm to 10 mm. In some embodiments, the gap is 2 mm to 10 mm. In some embodiments, the gap is 3 mm to 10 mm. In some embodiments, the gap is 4 mm to 10 mm. In some embodiments, the gap is 5 mm to 10 mm. In some embodiments, the gap is 6 mm to 10 mm. In some embodiments, the gap is 7 mm to 10 mm. In some embodiments, the gap is 8 mm to 10 mm. In some embodiments, the gap is 9 mm to 10 mm.

In some embodiments, the gap is 1 mm to 9 mm. In some embodiments, the gap is 2 mm to 9 mm. In some embodiments, the gap is 3 mm to 9 mm. In some embodiments, the gap is 4 mm to 9 mm. In some embodiments, the gap is 5 mm to 9 mm. In some embodiments, the gap is 6 mm to 9 mm. In some embodiments, the gap is 7 mm to 9 mm. In some embodiments, the gap is 8 mm to 9 mm.

In some embodiments, the gap is 1 mm to 8 mm. In some embodiments, the gap is 2 mm to 8 mm. In some embodiments, the gap is 3 mm to 8 mm. In some embodiments, the gap is 4 mm to 8 mm. In some embodiments, the gap is 5 mm to 8 mm. In some embodiments, the gap is 6 mm to 8 mm. In some embodiments, the gap is 7 mm to 8 mm.

In some embodiments, the gap is 1 mm to 7 mm. In some embodiments, the gap is 2 mm to 7 mm. In some embodiments, the gap is 3 mm to 7 mm. In some embodiments, the gap is 4 mm to 7 mm. In some embodiments, the gap is 5 mm to 7 mm. In some embodiments, the gap is 6 mm to 7 mm.

In some embodiments, the gap is 1 mm to 6 mm. In some embodiments, the gap is 2 mm to 6 mm. In some embodiments, the gap is 3 mm to 6 mm. In some embodiments, the gap is 4 mm to 6 mm. In some embodiments, the gap is 5 mm to 6 mm.

In some embodiments, the gap is 1 mm to 5 mm. In some embodiments, the gap is 2 mm to 5 mm. In some embodiments, the gap is 3 mm to 5 mm. In some embodiments, the gap is 4 mm to 5 mm.

In some embodiments, the gap is 1 mm to 4 mm. In some embodiments, the gap is 2 mm to 4 mm. In some embodiments, the gap is 3 mm to 4 mm.

In some embodiments, the gap is 1 mm to 3 mm. In some embodiments, the gap is 2 mm to 3 mm. In some embodiments, the gap is 1 mm to 2 mm.

In some embodiments, the gap is 1 mm. In some embodiments, the gap is 2 mm. In some embodiments, the gap is 3 mm. In some embodiments, the gap is 4 mm. In some embodiments, the gap is 5 mm. In some embodiments, the gap is 6 mm. In some embodiments, the gap is 7 mm. In some embodiments, the gap is 8 mm. In some embodiments, the gap is 9 mm. In some embodiments, the gap is 10 mm.

In some embodiments, the gap is an air gap. In some embodiments, the gap is filled with an insulating material.

In some embodiments, the first support comprises a first protrusion. In some embodiments, the first support comprises a first protrusion and a second protrusion spaced apart from the first protrusion. In some embodiments, the first support comprises more than two protrusions spaced apart from one another. In some embodiments, the distance that the two protrusions are spaced apart from one another is measured from portions of the protrusions closest to one another.

In some embodiments, a distance between the first protrusion and the second protrusion is 20 mm to 120 mm. In some embodiments, the distance is 30 mm to 120 mm. In some embodiments, the distance is 40 mm to 120 mm. In some embodiments, the distance is 50 mm to 120 mm. In some embodiments, the distance is 60 mm to 120 mm. In some embodiments, the distance is 70 mm to 120 mm. In some embodiments, the distance is 80 mm to 120 mm. In some embodiments, the distance is 90 mm to 120 mm. In some embodiments, the distance is 100 mm to 120 mm. In some embodiments, the distance is 110 mm to 120 mm.

In some embodiments, a distance between the first protrusion and the second protrusion is 20 mm to 110 mm. In some embodiments, the distance is 30 mm to 110 mm. In some embodiments, the distance is 40 mm to 110 mm. In some embodiments, the distance is 50 mm to 110 mm. In some embodiments, the distance is 60 mm to 110 mm. In some embodiments, the distance is 70 mm to 110 mm. In some embodiments, the distance is 80 mm to 110 mm. In some embodiments, the distance is 90 mm to 110 mm. In some embodiments, the distance is 100 mm to 110 mm.

In some embodiments, a distance between the first protrusion and the second protrusion is 20 mm to 100 mm. In some embodiments, the distance is 30 mm to 100 mm. In some embodiments, the distance is 40 mm to 100 mm. In some embodiments, the distance is 50 mm to 100 mm. In some embodiments, the distance is 60 mm to 100 mm. In some embodiments, the distance is 70 mm to 100 mm. In some embodiments, the distance is 80 mm to 100 mm. In some embodiments, the distance is 90 mm to 100 mm. In some embodiments, the distance is 90 mm to 100 mm.

In some embodiments, a distance between the first protrusion and the second protrusion is 20 mm to 90 mm. In some embodiments, the distance is 30 mm to 90 mm. In some embodiments, the distance is 40 mm to 90 mm. In some embodiments, the distance is 50 mm to 90 mm. In some embodiments, the distance is 60 mm to 90 mm. In some embodiments, the distance is 70 mm to 90 mm. In some embodiments, the distance is 80 mm to 90 mm.

In some embodiments, a distance between the first protrusion and the second protrusion is 20 mm to 80 mm. In some embodiments, the distance is 30 mm to 80 mm. In some embodiments, the distance is 40 mm to 80 mm. In some embodiments, the distance is 50 mm to 80 mm. In some embodiments, the distance is 60 mm to 80 mm. In some embodiments, the distance is 70 mm to 80 mm.

In some embodiments, a distance between the first protrusion and the second protrusion is 20 mm to 70 mm. In some embodiments, the distance is 30 mm to 70 mm. In some embodiments, the distance is 40 mm to 70 mm. In some embodiments, the distance is 50 mm to 70 mm. In some embodiments, the distance is 60 mm to 70 mm.

In some embodiments, a distance between the first protrusion and the second protrusion is 20 mm to 60 mm. In some embodiments, the distance is 30 mm to 60 mm. In some embodiments, the distance is 40 mm to 60 mm. In some embodiments, the distance is 50 mm to 60 mm.

In some embodiments, a distance between the first protrusion and the second protrusion is 20 mm to 50 mm. In some embodiments, the distance is 30 mm to 50 mm. In some embodiments, the distance is 40 mm to 50 mm.

In some embodiments, a distance between the first protrusion and the second protrusion is 20 mm to 40 mm. In some embodiments, the distance is 30 mm to 40 mm. In some embodiments, a distance between the first protrusion and the second protrusion is 20 mm to 30 mm.

In some embodiments, the distance is 10 mm. In some embodiments, the distance is 20 mm. In some embodiments, the distance is 30 mm. In some embodiments, the distance is 40 mm. In some embodiments, the distance is 50 mm. In some embodiments, the distance is 60 mm. In some embodiments, the distance is 70 mm. In some embodiments, the distance is 80 mm. In some embodiments, the distance is 90 mm. In some embodiments, the distance is 100 mm. In some embodiments, the distance is 90 mm. In some embodiments, the distance is 110 mm. In some embodiments, the distance is 90 mm. In some embodiments, the distance is 120 mm.

In some embodiments, a return wire is in electrical connection with the photovoltaic module. In some embodiments, a return wire connector is in electrical connection with the return wire. In some embodiments, the photovoltaic modules further comprises a second support located on the baseplate. In some embodiments, the return wire connector is located on the second support of the first photovoltaic module so that the return wire connector is out of contact with the baseplate of the first photovoltaic module. In some embodiments, the second support of the first photovoltaic module supports the return wire so that the return wire is out of contact with the baseplate of the first photovoltaic module.

In some embodiments, the second support comprises a polymer. In some embodiments, the second support comprises a composite material. In some embodiments, the second support comprises silicone. In some embodiments, the second support comprises at least one of poly (p-phenylene ether) (PPE), or polystyrene (PS). In some embodiments, the second support comprises combinations of two or more of the foregoing materials. In some embodiments, the second support comprises another material.

In some embodiments, the second support comprises a material with a thermal conductivity of 0.02 W/m-K to 0.4 W/m-K. In some embodiments, the thermal conductivity is 0.03 W/m-K to 0.4 W/m-K. In some embodiments, the thermal conductivity is 0.04 W/m-K to 0.4 W/m-K. In some embodiments, the thermal conductivity is 0.05 W/m-K to 0.4 W/m-K. In some embodiments, the thermal conductivity is 0.1 W/m-K to 0.4 W/m-K. In some embodiments, the thermal conductivity is 0.2 W/m-K to 0.4 W/m-K. In some embodiments, the thermal conductivity is 0.3 W/m-K to 0.4 W/m-K.

In some embodiments, the thermal conductivity is 0.02 W/m-K to 0.3 W/m-K. In some embodiments, the thermal conductivity is 0.03 W/m-K to 0.3 W/m-K. In some embodiments, the thermal conductivity is 0.04 W/m-K to 0.3 W/m-K. In some embodiments, the thermal conductivity is 0.05 W/m-K to 0.3 W/m-K. In some embodiments, the thermal conductivity is 0.1 W/m-K to 0.3 W/m-K. In some embodiments, the thermal conductivity is 0.2 W/m-K to 0.3 W/m-K.

In some embodiments, the thermal conductivity is 0.02 W/m-K to 0.2 W/m-K. In some embodiments, the thermal conductivity is 0.03 W/m-K to 0.2 W/m-K. In some embodiments, the thermal conductivity is 0.04 W/m-K to 0.2 W/m-K. In some embodiments, the thermal conductivity is 0.05 W/m-K to 0.2 W/m-K. In some embodiments, the thermal conductivity is 0.1 W/m-K to 0.2 W/m-K.

In some embodiments, the thermal conductivity is 0.02 W/m-K to 0.1 W/m-K. In some embodiments, the thermal conductivity is 0.03 W/m-K to 0.1 W/m-K. In some embodiments, the thermal conductivity is 0.04 W/m-K to 0.1 W/m-K. In some embodiments, the thermal conductivity is 0.05 W/m-K to 0.1 W/m-K.

In some embodiments, the thermal conductivity is 0.02 W/m-K to 0.05 W/m-K. In some embodiments, the thermal conductivity is 0.03 W/m-K to 0.05 W/m-K. In some embodiments, the thermal conductivity is 0.04 W/m-K to 0.05 W/m-K.

In some embodiments, the thermal conductivity is 0.02 W/m-K to 0.04 W/m-K. In some embodiments, the thermal conductivity is 0.03 W/m-K to 0.04 W/m-K. In some embodiments, the thermal conductivity is 0.02 W/m-K to 0.03 W/m-K. In some embodiments, the thermal conductivity is less than 0.3 W/m-K.

In some embodiments, the second support comprises the same material as the baseplate. In some embodiments, the second support comprises a different material as the baseplate.

In some embodiments, the second support is connected to the baseplate. In some embodiments, the second support is adhered the baseplate. In some embodiments, the second support is adhered the baseplate by an adhesive. In some embodiments, the second support is welded to the baseplate. In some embodiments, the second support is ultrasonically welded to the baseplate. In some embodiments, the second support is laminated to the baseplate. In some embodiments, the second support is formed with the baseplate. In some embodiments, the second support is injection molded with the baseplate. In some embodiments, the second support is co-molded with the baseplate. In some embodiments, the second support is insert molded with the baseplate. In some embodiments, the second support is not attached to the baseplate.

In some embodiments, the second support supports the return wire, such that the return wire is separated from the baseplate of the first photovoltaic module by a gap (e.g., at least a portion of the return wire does not contact the baseplate).

In some embodiments, the gap is 1 mm to 10 mm. In some embodiments, the gap is 2 mm to 10 mm. In some embodiments, the gap is 3 mm to 10 mm. In some embodiments, the gap is 4 mm to 10 mm. In some embodiments, the gap is 5 mm to 10 mm. In some embodiments, the gap is 6 mm to 10 mm. In some embodiments, the gap is 7 mm to 10 mm. In some embodiments, the gap is 8 mm to 10 mm. In some embodiments, the gap is 9 mm to 10 mm.

In some embodiments, the gap is 1 mm to 9 mm. In some embodiments, the gap is 2 mm to 9 mm. In some embodiments, the gap is 3 mm to 9 mm. In some embodiments, the gap is 4 mm to 9 mm. In some embodiments, the gap is 5 mm to 9 mm. In some embodiments, the gap is 6 mm to 9 mm. In some embodiments, the gap is 7 mm to 9 mm. In some embodiments, the gap is 8 mm to 9 mm.

In some embodiments, the gap is 1 mm to 8 mm. In some embodiments, the gap is 2 mm to 8 mm. In some embodiments, the gap is 3 mm to 8 mm. In some embodiments, the gap is 4 mm to 8 mm. In some embodiments, the gap is 5 mm to 8 mm. In some embodiments, the gap is 6 mm to 8 mm. In some embodiments, the gap is 7 mm to 8 mm.

In some embodiments, the gap is 1 mm to 7 mm. In some embodiments, the gap is 2 mm to 7 mm. In some embodiments, the gap is 3 mm to 7 mm. In some embodiments, the gap is 4 mm to 7 mm. In some embodiments, the gap is 5 mm to 7 mm. In some embodiments, the gap is 6 mm to 7 mm.

In some embodiments, the gap is 1 mm to 6 mm. In some embodiments, the gap is 2 mm to 6 mm. In some embodiments, the gap is 3 mm to 6 mm. In some embodiments, the gap is 4 mm to 6 mm. In some embodiments, the gap is 5 mm to 6 mm.

In some embodiments, the gap is 1 mm to 5 mm. In some embodiments, the gap is 2 mm to 5 mm. In some embodiments, the gap is 3 mm to 5 mm. In some embodiments, the gap is 4 mm to 5 mm.

In some embodiments, the gap is 1 mm to 4 mm. In some embodiments, the gap is 2 mm to 4 mm. In some embodiments, the gap is 3 mm to 4 mm.

In some embodiments, the gap is 1 mm to 3 mm. In some embodiments, the gap is 2 mm to 3 mm. In some embodiments, the gap is 1 mm to 2 mm.

In some embodiments, the gap is 1 mm. In some embodiments, the gap is 2 mm. In some embodiments, the gap is 3 mm. In some embodiments, the gap is 4 mm. In some embodiments, the gap is 5 mm. In some embodiments, the gap is 6 mm. In some embodiments, the gap is 7 mm. In some embodiments, the gap is 8 mm. In some embodiments, the gap is 9 mm. In some embodiments, the gap is 10 mm.

In some embodiments, the gap is an air gap. In some embodiments, the gap is filled with an insulating material.

In some embodiments, the second support comprises a third protrusion. In some embodiments, the second support comprises a third protrusion and a fourth protrusion spaced apart from the first protrusion. In some embodiments, the second support comprises more than two protrusions spaced apart from one another. In some embodiments, the distance that the two protrusions are spaced apart from one another is measured from portions of the protrusions closest to one another.

In some embodiments, a distance between the first protrusion and the second protrusion is 20 mm to 120 mm. In some embodiments, the distance is 30 mm to 120 mm. In some embodiments, the distance is 40 mm to 120 mm. In some embodiments, the distance is 50 mm to 120 mm. In some embodiments, the distance is 60 mm to 120 mm. In some embodiments, the distance is 70 mm to 120 mm. In some embodiments, the distance is 80 mm to 120 mm. In some embodiments, the distance is 90 mm to 120 mm. In some embodiments, the distance is 100 mm to 120 mm. In some embodiments, the distance is 110 mm to 120 mm.

In some embodiments, a distance between the first protrusion and the second protrusion is 20 mm to 110 mm. In some embodiments, the distance is 30 mm to 110 mm. In some embodiments, the distance is 40 mm to 110 mm. In some embodiments, the distance is 50 mm to 110 mm. In some embodiments, the distance is 60 mm to 110 mm. In some embodiments, the distance is 70 mm to 110 mm. In some embodiments, the distance is 80 mm to 110 mm. In some embodiments, the distance is 90 mm to 110 mm. In some embodiments, the distance is 100 mm to 110 mm.

In some embodiments, a distance between the first protrusion and the second protrusion is 20 mm to 100 mm. In some embodiments, the distance is 30 mm to 100 mm. In some embodiments, the distance is 40 mm to 100 mm. In some embodiments, the distance is 50 mm to 100 mm. In some embodiments, the distance is 60 mm to 100 mm. In some embodiments, the distance is 70 mm to 100 mm. In some embodiments, the distance is 80 mm to 100 mm. In some embodiments, the distance is 90 mm to 100 mm.

In some embodiments, a distance between the first protrusion and the second protrusion is 20 mm to 90 mm. In some embodiments, the distance is 30 mm to 90 mm. In some embodiments, the distance is 40 mm to 90 mm. In some embodiments, the distance is 50 mm to 90 mm. In some embodiments, the distance is 60 mm to 90 mm. In some embodiments, the distance is 70 mm to 90 mm. In some embodiments, the distance is 80 mm to 90 mm.

In some embodiments, a distance between the first protrusion and the second protrusion is 20 mm to 80 mm. In some embodiments, the distance is 30 mm to 80 mm. In some embodiments, the distance is 40 mm to 80 mm. In some embodiments, the distance is 50 mm to 80 mm. In some embodiments, the distance is 60 mm to 80 mm. In some embodiments, the distance is 70 mm to 80 mm.

In some embodiments, a distance between the first protrusion and the second protrusion is 20 mm to 70 mm. In some embodiments, the distance is 30 mm to 70 mm. In some embodiments, the distance is 40 mm to 70 mm. In some embodiments, the distance is 50 mm to 70 mm. In some embodiments, the distance is 60 mm to 70 mm.

In some embodiments, a distance between the first protrusion and the second protrusion is 20 mm to 60 mm. In some embodiments, the distance is 30 mm to 60 mm. In some embodiments, the distance is 40 mm to 60 mm. In some embodiments, the distance is 50 mm to 60 mm.

In some embodiments, a distance between the first protrusion and the second protrusion is 20 mm to 50 mm. In some embodiments, the distance is 30 mm to 50 mm. In some embodiments, the distance is 40 mm to 50 mm.

In some embodiments, a distance between the first protrusion and the second protrusion is 20 mm to 40 mm. In some embodiments, the distance is 30 mm to 40 mm. In some embodiments, a distance between the first protrusion and the second protrusion is 20 mm to 30 mm.

In some embodiments, the distance is 10 mm. In some embodiments, the distance is 20 mm. In some embodiments, the distance is 30 mm. In some embodiments, the distance is 40 mm. In some embodiments, the distance is 50 mm. In some embodiments, the distance is 60 mm. In some embodiments, the distance is 70 mm. In some embodiments, the distance is 80 mm. In some embodiments, the distance is 90 mm. In some embodiments, the distance is 100 mm.

In some embodiments, the photovoltaic module is a first photovoltaic module installed on the roof deck. In some embodiments, the roofing system includes another photovoltaic module installed on the roof deck. In some embodiments, the second photovoltaic module at least partially overlaps the first photovoltaic module. In some embodiments, the first photovoltaic module at least partially overlaps the second photovoltaic module. In some embodiments, the roofing system includes one or more, or all of, one or more of the photovoltaic modules, one or more of the non-photovoltaic modules, one or more electrical wires, one or more return wires, one or more electrical connectors, one or more return connectors, and/or one or more other components.

In some embodiments, one or more of the first and second protrusions of the first support, and/or either or both of the third and fourth protrusions of the second support, are formed, positioned, and/or otherwise located on a portion of the electrical component, such as but not limited to the junction box, the power optimizer, and/or the rapid shutdown device.

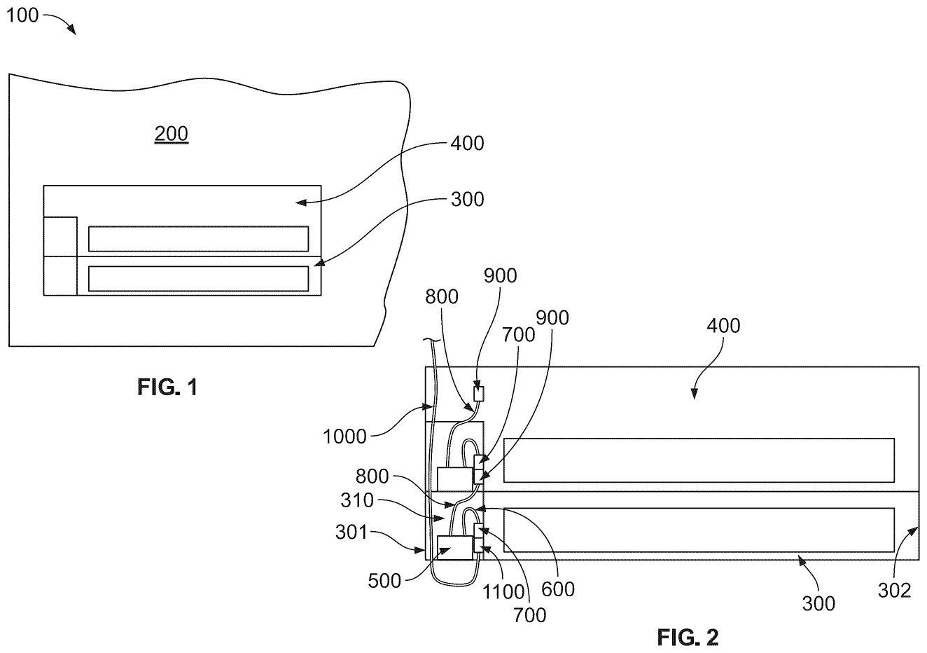

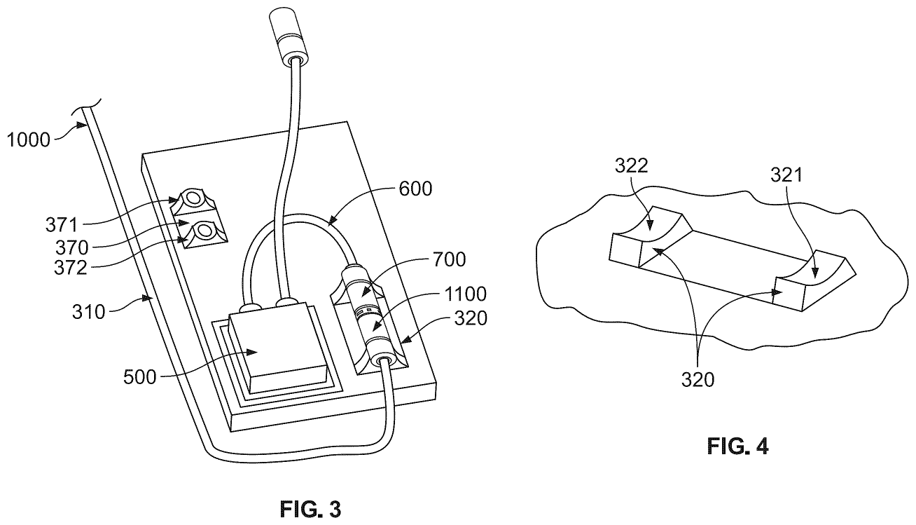

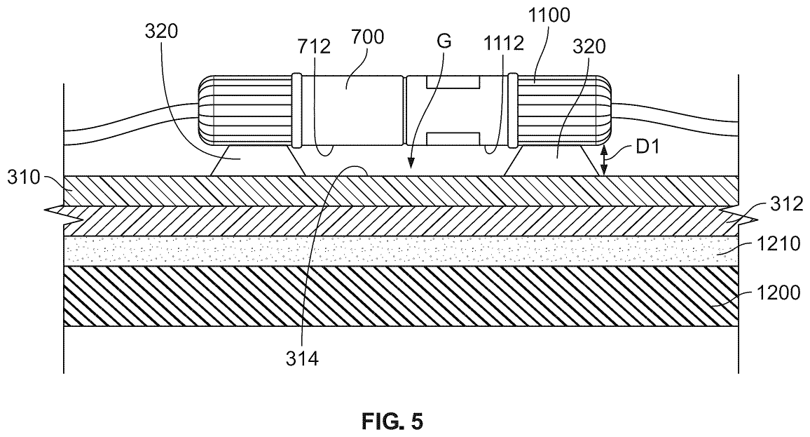

With reference to the figures, FIG. 1 is a top schematic view of a roofing system 100 including a roof deck 200, a first photovoltaic module 300 with a baseplate 310 and a first support 320, and a second photovoltaic module 400 partially overlapping the first photovoltaic module 300, among other components; FIG. 2 is a top schematic detail view of the first photovoltaic module 300 and the second photovoltaic module 400 of FIG. 1; and FIGS. 3 and 4 are isometric schematic views of the baseplate 310 and the first support 320 of the first photovoltaic module 300, according to some embodiments of the invention. It is to be understood that, in some embodiments, the second photovoltaic module 400 includes a similar structure as the first photovoltaic module 300, as shown in the figures, and as described herein. Further, although FIGS. 1-4 show embodiments of the roofing system 100 which include two photovoltaic modules—the first photovoltaic module 300 and the second photovoltaic module 400—installed on the roof deck 200, as discussed, in some embodiments, the roofing system 100 includes more than two photovoltaic modules installed on the roof deck 200.

As FIGS. 1-4 illustrate, in some embodiments, the first photovoltaic module 300 include a first end 301 and a second end 302 opposite the first end 301. In some embodiments, the baseplate 310 is located at the first end 301. In some embodiments, the baseplate 310 is located at the second end 302.

In some embodiments, the first support 320 is located on the baseplate 310. In some embodiments, an electrical component 500 is located on the baseplate 310. As discussed, in some embodiments, the electrical component is one or more of a junction box, a power optimizer, and/or another component.

As the figures show, in some embodiments, the roofing system 100 includes a first electrical wire 600. In some embodiments, as described, the first electrical wire 600 is in electrical connection with the electrical component 500. Also as described, in some embodiments, a first electrical connector 700 is in electrical connection with the first electrical wire 600. As FIGS. 1-4 show, in some embodiments, either or both of the first electrical connector 700 and/or the first electrical wire 600 is located on the first support 320 so that either or both of the first electrical connector 700 and/or the first electrical wire 600 is out of contact with the baseplate 310. Thus, as described, in some embodiments, either or both of the first electrical connector 700 and/or the first electrical wire 600 is separated from the baseplate 310 by a gap. In some embodiments, the gap may be as described above.

As the figures show, in some embodiments, the first support 320 includes a first protrusion 321 and a second protrusion 322 that is spaced apart from the first protrusion 321. In some embodiments, as shown and described, the first protrusion 321 and the second protrusion 322 are spaced apart by a distance. In some embodiments, the distance may be as described above. In some embodiments, one or more surfaces of the first protrusion 321 and/or the second protrusion 322 may be sized, shaped, and/or oriented so as to retain either or both of the first electrical wire 600 and/or the first electrical connector 700. For example, in some embodiments, one or more surfaces of the first protrusion 321 and/or the second protrusion 322 has a shape or contour corresponding to a shape or contour of the first electrical wire 600 and/or the first electrical connector 700. In some embodiments, one or both of the first protrusion 321 and/or the second protrusion 322 includes a feature, such as a snap, lock, or other feature, which retains the first electrical wire 600 and/or the first electrical connector 700.

As FIGS. 1-4 show, in some embodiments, the electrical component 500 includes a second electrical wire 800. In some embodiments, a second electrical connector 900 is in electrical connection with the second electrical wire 800. Thus, as FIGS. 1-4 illustrate, in some embodiments, when the roofing system 100 includes a plurality of photovoltaic modules installed on the roof deck 200, and each of the photovoltaic modules include the electrical components 500, the first electrical connector 700 connected to the electrical component 500 on one of the photovoltaic modules is coupled to the second electrical connector 900 connected to the electrical component on another one of the photovoltaic modules.

As FIGS. 1-4 illustrate, in some embodiments, the first photovoltaic module 300 includes a second support 370. In some embodiments, the second support 370 is located on the baseplate 310.

As the figures show, in some embodiments, the roofing system 100 includes a return wire 1000. In some embodiments, the roofing system 100 includes a return wire connector 1100. In some embodiments, as described, the first electrical wire 600 is in electrical connection with the electrical component 500. Also as described, in some embodiments, the first electrical connector 700 is in electrical connection with the first electrical wire 600. As illustrated in FIGS. 1-4, in some embodiments, the return wire connector 1100 is coupled to the first electrical connector 700. In some embodiments, the return wire 1000 is located on the second support 370 so that at least a portion of the return wire 1000 is out of contact with the baseplate 310. Thus, as described, in some embodiments, at least a portion of the return wire 1000 is separated from the baseplate 310 by a gap. In some embodiments, the gap may be as described above.

As FIGS. 1-4 show, in some embodiments, the second support 370 includes a third protrusion 371 and a fourth protrusion 372 that is spaced apart from the third protrusion 371. In some embodiments, as shown and described, the third protrusion 371 and the fourth protrusion 372 are spaced apart by a distance. In some embodiments, the distance may be as described above. In some embodiments, one or more surfaces of the third protrusion 371 and/or the fourth protrusion 372 may be sized, shaped, and/or oriented so as to retain the return wire 1000. For example, in some embodiments, one or more surfaces of the third protrusion 371 and/or the fourth protrusion 372 has a shape or contour corresponding to a shape or contour of the return wire 1000. In some embodiments, one or both of the third protrusion 371 and/or the fourth protrusion 372 includes a feature, such as a snap, lock, or other feature, which retains the return wire 1000.

Referring to FIG. 5, in some embodiments, the baseplate 310 having the first support 320 is shown on a first layer 312 of the photovoltaic module 300. In some embodiments, the first layer 312 is a backsheet. In some embodiments, the first layer 312 is a lowermost layer of the photovoltaic module 300. In some embodiments, the first layer 312 is composed of a polymer. In some embodiments, the first layer 312 is composed of thermoplastic polyolefin (TPO). In some embodiments, the first layer 312 is composed of metal.

In some embodiments, the photovoltaic module 300 is installed above a roof deck 1200. In some embodiments, the roof deck 1200 is composed of wood. In some embodiments, the roof deck 1200 is composed of a polymer. In some embodiments, the roof deck 1200 is composed of a composite material. In some embodiments, an underlayment layer 1210 is installed above the roof deck 1200. In some embodiments, the photovoltaic module 300 is installed above the underlayment layer 1210.

In some embodiments, there is a gap G having a height D1 between an upper surface 314 of the first layer 312 and lower surfaces 712, 1112 of the connectors, 700, 1100, respectively. In some embodiments, the height D1 of the gap G is 1 mm to 10 mm. In some embodiments, the baseplate 310 is configured to maintain a minimum distance between the connectors 700, 1100 and the roof deck 1200 and/or underlayment layer 1210, as applicable. In some embodiments, this combination of the physical separation between the connectors 700, 1100 and the roof deck 1200/underlayment layer 1210 and a highly insulating material of the supports 320 is intended to prevent potentially damaging heat flow emanating from a faulty one of the connectors 700, 1100 to the roof deck 1200.

Variations, modifications, and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

What is claimed is:

1. A system, comprising:
a roof deck;
at least one photovoltaic module installed on the roof deck,
wherein the at least one photovoltaic module comprises a first photovoltaic module,
wherein each photovoltaic module includes:
a first end and a second end opposite the first end,
a baseplate located at the first end,
a first support located on the baseplate, and
an electrical component located on the baseplate;
a first electrical connector in electrical connection with the first photovoltaic module, and
wherein the first electrical connector is located on the first support of the first photovoltaic module so that the first electrical connector is out of contact with the baseplate of the first photovoltaic module.

2. The system of claim 1, wherein the first support comprises a polymer.

3. The system of claim 1, wherein the first support comprises a composite material.

4. The system of claim 1, wherein the first support comprises silicone.

5. The system of claim 1, wherein the first support comprises at least one of poly (p-phenylene ether) (PPE), or polystyrene (PS).

6. The system of claim 1, wherein the first support comprises a material with a thermal conductivity of 0.02 W/m-K to 0.2 W/m-K.

7. The system of claim 1, wherein the first support comprises a material with a thermal conductivity of 0.1 W/m-K to 0.2 W/m-K.

8. The system of claim 1, wherein the first support comprises a material with a thermal conductivity of 0.02 W/m-K to 0.05 W/m-K.

9. The system of claim 1, wherein the first support comprises a material with a thermal conductivity of less than 0.3 W/m-K.

10. The system of claim 1, wherein the first support comprises a same material as the baseplate.

11. The system of claim 1, wherein the first support comprises a different material than the baseplate.

12. The system of claim 1, wherein the first electrical connector separated from the baseplate of the first photovoltaic module by a gap, wherein the gap is 1 mm to 5 mm.

13. The system of claim 12, wherein the gap is 3 mm.

14. The system of claim 1, wherein the first support comprises a first protrusion and a second protrusion spaced apart from the first protrusion.

15. The system of claim 14, wherein a distance between the first protrusion and the second protrusion is 50 mm to 80 mm.

16. The system of claim 15, wherein the distance is 70 mm.

17. The system of claim 1, further comprising:
a return wire, and
a return wire connector in electrical connection with the return wire, and
wherein each photovoltaic module further comprises:
a second support located on the baseplate,
wherein the return wire connector is located on the second support of the first photovoltaic module so that the return wire connector is out of contact with the baseplate of the first photovoltaic module.

18. The system of claim 1, wherein the at least one photovoltaic module comprises a second photovoltaic module installed on the roof deck, wherein the second photovoltaic module at least partially overlaps the first photovoltaic module.

19. The system of claim 1, further comprising:
a first electrical wire in electrical connection with the electrical component of the first photovoltaic module.

20. A system, comprising:
a roof deck;
at least one photovoltaic module installed on the roof deck,
wherein the at least one photovoltaic module comprises a first photovoltaic module,
wherein each photovoltaic module includes:
a first end and a second end opposite the first end,
a baseplate located at the first end,
a first support located on the baseplate,
an electrical component located on the baseplate,
a first electrical wire in electrical connection with the electrical component of the first photovoltaic module; and
a first electrical connector in electrical connection with the first electrical wire,
wherein the first support of the first photovoltaic module supports the first electrical wire so that the first electrical connector is out of contact with the baseplate of the first photovoltaic module.
